(19) United States
(12) Patent Application Publication
(10) Pub. No.: US 2023/0077376 A1
(43) Pub. Date: Mar. 16, 2023

(54) ULTRAVIOLET LAMP WITH MINIMIZED OZONE GENERATION

(71) Applicant: Langsim Optoelectronic Technologies (Guangdong) Limited, Foshan (CN)

(72) Inventor: Jiawei Li, Xiamen (CN)

(21) Appl. No.: 17/729,941

(22) Filed: Apr. 26, 2022

(30) Foreign Application Priority Data
Sep. 11, 2021 (CN) 202122195087.0

(51) Int. Cl. H01H 33/04; F21V 23/06; F21V 23/00

(52) U.S. Cl. CPC H01H 33/045; F21V 23/06; F21V 23/002

(57) ABSTRACT

This application discloses an ultraviolet lamp with minimized ozone generation, the ultraviolet lamp comprising an outer tube; an inner tube arranged across the interior of the outer tube; an outer electrode installed on the outside wall of the outer tube; and an inner electrode installed on the inner side of the tube; wherein the outer electrode is in surface contact with the outside wall of the outer tube; and the width of the contact surface between the outer electrode and the outer tube is equal to the width of the effective electric field generated between the outer electrode and the inner electrode. Thus, because there is no discharge area between the outer electrode and the outer tube, when the outer electrode is connected to a high voltage, there is no discharge in the air, and no ozone is generated.

### CROSS-REFERENCE TO RELATED APPLICATION

This application claims priority under 35 U.S.C. § 119(a) to Chinese Patent Application No. 202122195087.0, filed on Sep. 11, 2021 with the China National Intellectual Property Administration, the disclosure of which is incorporated herein by reference in its entirety.

### FIELD OF THE DISCLOSURE

The present disclosure relates to the technical field of ultraviolet lamps, in particular, an ultraviolet lamp with minimized ozone generation.

### BACKGROUND OF THE DISCLOSURE

Ultraviolet light, like visible light and infrared light, is produced by the excitation of electrons in the outer shell of atoms. For example, when the mercury atoms in the mercury vapor are excited by electrical energy, ultraviolet light can be emitted. In order to increase the effective distance, it is necessary to use quartz glass as the tube material. The existing cylindrical UV lamp, as shown in FIG. 1, usually uses a metal wire 3 with a round cross section to be wound on the outside wall of the outer tube 2. During operation, when the metal wire 3 is connected to a high voltage, the electric field is generated between the metal wire 3 and the inner electrode, so that the electrons in the outer shell of the atoms are excited to generate ultraviolet light. Since the circular metal wire 3 is in line contact with the outer tube 2, there is a discharge area 1 between the part swept by the effective electric field generated by the metal wire and the outer tube 2. When the metal wire 3 is connected to a high voltage, the metal wire 3 and the outer tube 2 will generate a discharge phenomenon in the air in the discharge area 1, thereby converting some oxygen in the air into ozone, the strong oxidizing property of ozone has certain harmful effects on human health.

To this end, we propose a UV lamp with minimized ozone generation to solve the problems mentioned above.

### SUMMARY OF THE DISCLOSURE

Aiming at the above-mentioned defect of the existing UV lamp that ozone is easily generated, resulting in harmful effects on human health, the present disclosure provides an ultraviolet lamp with minimized ozone generation to overcome the defect.

In one aspect, the present disclosure provides an ultraviolet lamp capable of avoiding or reducing ozone generation, the ultraviolet lamp comprising an outer tube; an inner tube arranged across the interior of the outer tube; an outer electrode installed on the outside wall of the outer tube; and an inner electrode installed on the inner side of the inner tube; wherein the outer electrode is in surface contact with the outside wall of the outer tube; and the width of the contact surface between the outer electrode and the outer tube is equal to the width of the effective electric field generated between the outer electrode and the inner electrode.

In one embodiment, sometimes preferred, the outer electrode is a metal wire being wound around the outside wall of the outer tube.

In one embodiment, sometimes preferred, the cross section of the outer electrode is a triangular structure.

In one embodiment, sometimes preferred, the outer electrode is silver glue or conductive glue printed on the outside wall of the outer tube.

In one embodiment, sometimes preferred, the cross section of the outer electrode is a semicircle or a semielliptical structure.

In one embodiment, the metal wire has a triangular prism structure having a cross section in a triangular shape and three flat surfaces along longitudinal direction of the wire.

In one embodiment, one of the three flat surfaces along cross the longitudinal direction of the metal wire is the contact surface of the metal wire with the outside wall of the outer tube.

In one embodiment, the metal wire has a semi-cylindrial structure having a cross section in a semi-circle shape and a flat surface along longitudinal direction of the wire.

In one embodiment, the flat surface along the longitudinal direction of the wire is the contact surface of the metal wire with the outside wall of the outer tube.

In one embodiment, the metal wire has a semi-elliptical cylindrial structure having a cross section in a semi-elliptical shape and a flat surface along longitudinal direction of the wire.

In one embodiment, the flat surface along the longitudinal direction of the wire is the contact surface of the metal wire with the outside wall of the outer tube.

In one embodiment, the outer electrode is a conductive glue printed on the outside wall of the outer tube.

In one embodiment, the outer electrode is a silver glue printed on the outside wall of the outer tube.

In another aspect, the present disclosure provides a device comprising an ultraviolet lamp according to any embodiment disclosed herein, for example, while not intended to be limiting, the ultraviolet lamp can be used in a disinfection device for antibacterial and/or antiviral applications, preferably in a space occupied by humans and/or animals, including but not limited to domestic pets or farm-raised animals, such as cats, dogs, monkeys, horses, pigs, cattles, poultry, or the like.

Advantages: since the outer electrode and the outside wall of the outer tube are in surface contact, and the width of the contact surface between the outer electrode and the outer tube is equal to the width of the effective electric field generated between the outer electrode and the inner electrode, when the outer electrode is connected to high voltage, there is no discharge area between the outer electrode and the outer tube, so there is no spark generation, and no or only minimum ozone is generated, thereby avoiding the harm of ozone to human health.

Other aspects or advantages of the present invention will be better appreciated in view of the following drawings, detailed description, examples, and claims.

### BRIEF DESCRIPTION OF THE DRAWINGS

FIG. 1 is a schematic structural diagram of the existing cylindrical UV lamp.

FIG. 2 is a schematic structural diagram of the ultraviolet lamp exemplified in Example 1.

FIG. 3 is an enlarged schematic view of the area A in FIG. 2.

FIG. 4 is a schematic structural diagram of the ultraviolet lamp exemplified in Example 2.

FIG. 5 is an enlarged schematic view of the area B in FIG. 4.

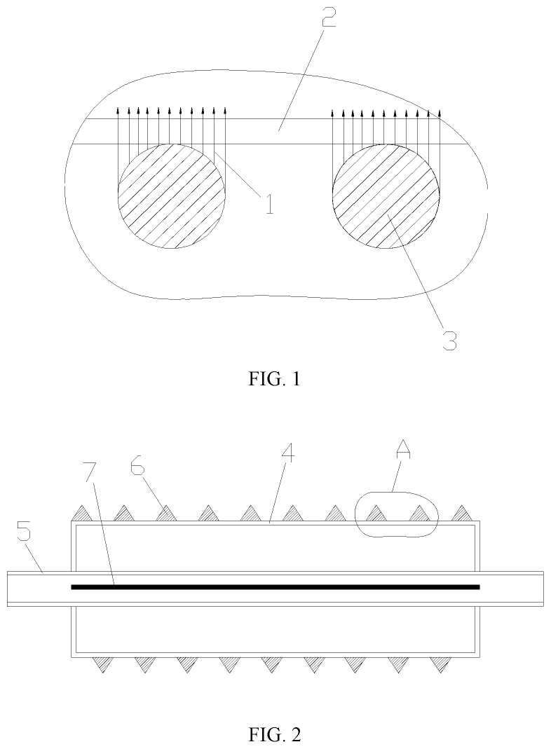

In the figures: 4—outer tube; 5—inner tube; 6—outer electrode; and 7—inner electrode.

### DETAILED DESCRIPTION OF CERTAIN EMBODIMENTS

Certain embodiments of the present invention will now be described in further detail with reference to the accompanying drawings. These drawings are all simplified schematic diagrams and only illustrate the basic structures of the UV lamps disclosed in a schematic manner.

In the present disclosure, it should be noted that the orientation or positional relationships indicated by the terms “inside”, “outside”, “between”, or the like, are based on the orientation or positional relationships shown in the accompanying drawings. They only serve for the convenience of describing the present invention and simplifying the description, rather than indicate or imply that the referred device or element must have a specific orientation, or be constructed and operated in a specific orientation, so they should not be construed to be limiting on the present invention. In addition, unless otherwise expressly specified and defined, the terms “install”, “wind”, and “connect” should be understood in a broad sense, for example, it can be a fixed connection, a detachable connection, or an integral connection; it can be a mechanical connection or an electrical connection; it can be a direct connection or an indirect connection through an intermediate medium; and it can be internal communication between two components of a unit. For those of ordinary skill in the art, the specific meanings of the above terms in the present disclosure can be understood under the specific circumstances.

### Example 1

As shown in FIGS. 2-3, Example 1 provides a cylindrical ultraviolet lamp capable of avoiding or reducing ozone generation. It includes: an outer tube 4, an inner tube 5 arranged across the interior of the outer tube 4, an outer electrode 6 installed on the outside wall of the outer tube 4, and an inner electrode 7 installed on the inner side of the inner tube 5, wherein the outer electrode 6 is in surface contact with the outside wall of the outer tube 4; and the contact surface width between the outer electrode 6 and the outer tube 4 is equal to the width of the effective electric field generated between the outer electrode 6 and the inner electrode 7. The outer electrode 6 is a metal wire, which is wound on the outside wall of the outer tube 4; the cross section of the outer electrode 6 is a triangular structure.

In the present UV lamp, because the outer electrode 6 and the outside wall of the outer tube 4 are in surface contact, and the width of the contact surface between the outer electrode 6 and the outer tube 4 is equal to the width of the effective electric field generated between the outer electrode 6 and the inner electrode 7, when the outer electrode 6 is connected to high voltage, there is no discharge area between the outer electrode 6 and the outer tube 4, so there is no spark generation; thus, no ozone is generated, thereby avoiding the harm of ozone to human health. Since the cross section of the outer electrode 6 is a triangular structure, during the winding process, the longest side should be selected as the contact surface with the outer tube 4 to ensure that the effective electric field generated between the outer electrode 6 and the inner electrode 7 falls completely within the surface contact area.

### Example 2

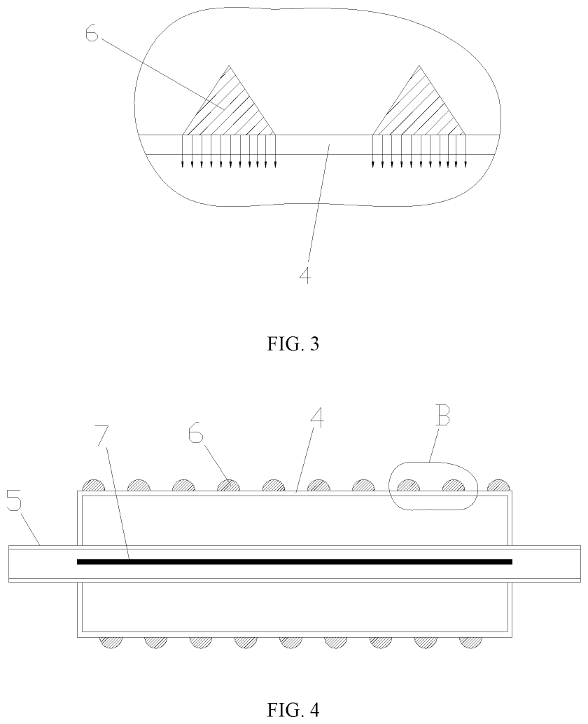

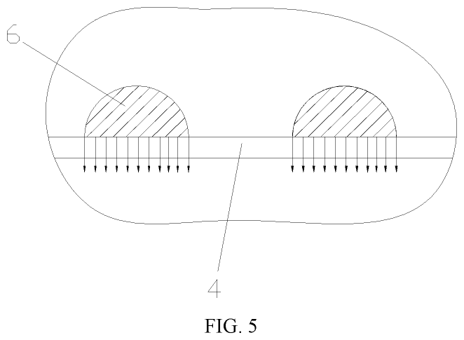

As shown in FIGS. 4-5, Example 2 provides a cylindrical UV lamp capable of avoiding or reducing ozone generation. It includes an outer tube 4, an inner tube 5 arranged across the interior of the outer tube 4, an outer electrode 6 installed on the outside wall of the outer tube 4, and an inner electrode 7 installed on the inner side of the inner tube 5, wherein the outer electrode 6 is in surface contact with the outer wall of the outer tube 4; the contact surface width between the outer electrode 6 and the outer tube 4 is equal to the width of the effective electric field generated between the outer electrode 6 and the inner electrode 7; and the outer electrode 6 is silver glue or conductive glue printed on the outside wall of the outer tube 4. The cross section of the outer electrode 6 is a semicircle or a semielliptical structure.

In the present UV lamp, since the outer electrode 6 and the outside wall of the outer tube 4 are in surface contact, and the width of the contact surface between the outer electrode 6 and the outer tube 4 is equal to the width of the effective electric field generated between the outer electrode 6 and the inner electrode 7, when the outer electrode 6 is connected to a high voltage, there is no discharge area between the outer electrode 6 and the outer tube 4, so there is no spark generation, and no ozone is generated, thereby avoiding the harm of ozone to human health. When the cross-section of the outer electrode 6 is a semicircle or a semi-elliptical structure, the plat side of the electrode should be selected as the contact surface, instead of contact between the curved surface and the outer tube 4, to ensure that the effective electric field generated between the outer electrode 6 and the inner electrode 7 completely falls within this surface contact area.

As a person of ordinary skill in the art would understand, the shape of the UV lamp does not have to be cylindrical, and other shapes, for example, flat ones, can also be paired with such an electrode structure to avoid the generation of ozone.

In the description of this specification, the reference terms such as “one embodiment,” “some embodiments,” “exemplary embodiment,” “example,” “specific example,” or “some examples”, or the like, mean that a particular feature, structure, material, or characteristic described in such embodiment or an example is included in at least one embodiment or illustrative example of the present invention. In this application, schematic representations of the above terms do not necessarily refer to the same embodiment or example. Furthermore, the particular features, structures, materials or characteristics described may be combined in a suitable manner in any one or more embodiments or examples.

The above has shown and described the basic principles and major features and advantages of the present invention, and it will be apparent to those skilled in the art that the present invention is not limited to the details of the above-described exemplary embodiments, and that without departing from the spirit or essential characteristics of the present invention, the present invention can be implemented in other specific forms. Therefore, the embodiments are to be regarded in all respects as illustrative and non-limiting, and the scope of the invention is defined by the appended claims rather than the foregoing description, and it is therefore intended to embrace within the present invention all changes or modifications that come within the meaning and range or equivalents of the claims. Any reference symbols or numbers to the drawings in the claims shall not be construed as limiting the involved claims.

In addition, it should be understood that although this invention is described in terms of embodiments, it is not the case that each embodiment only includes an independent technical solution, and this description in the specification is only for the purpose of clarity, and those skilled in the art should take the specification as a whole, since the technical solutions in each embodiment can also be appropriately combined to form other embodiments that can be understood by those skilled in the art.

What is claimed is:

1. An ultraviolet lamp comprising an outer tube, an inner tube arranged across interior of the outer tube, an outer electrode installed on outside wall of the outer tube, and an inner electrode installed on inner side of the inner tube, wherein the outer electrode is in surface contact with the outside wall of the outer tube; and wherein width of the contact surface between the outer electrode and the outer tube is equal to width of an effective electric field generated between the outer electrode and the inner electrode; and when the outer electrode is connected to a high voltage, no sparks will be generated between the outer electrode and the outer tube, thus avoiding or reducing generation of ozone.

2. The ultraviolet lamp of claim 1, wherein the outer electrode is a metal wire being wound around the outside wall of the outer tube.

3. The ultraviolet lamp of claim 2, wherein the metal wire has a triangular prism structure having a cross section in a triangular shape and three flat surfaces along longitudinal direction of the wire.

4. The ultraviolet lamp of claim 3, wherein one of the three flat surfaces along cross the longitudinal direction of the metal wire is the contact surface of the metal wire with the outside wall of the outer tube.

5. The ultraviolet lamp of claim 2, wherein the metal wire has a semi-cylindrial structure having a cross section in a semi-circle shape and a flat surface along longitudinal direction of the wire.

6. The ultraviolet lamp of claim 5, wherein the flat surface along the longitudinal direction of the wire is the contact surface of the metal wire with the outside wall of the outer tube.

7. The ultraviolet lamp of claim 2, wherein the metal wire has a semi-elliptical cylindrial structure having a cross section in a semi-elliptical shape and a flat surface along longitudinal direction of the wire.

8. The ultraviolet lamp of claim 7, wherein the flat surface along the longitudinal direction of the wire is the contact surface of the metal wire with the outside wall of the outer tube.

9. The ultraviolet lamp of claim 1, wherein the outer electrode is a conductive glue printed on the outside wall of the outer tube.

10. The ultraviolet lamp of claim 1, wherein the outer electrode is a silver glue printed on the outside wall of the outer tube.
